(19) United States
(12) Patent Application Publication
(10) Pub. No.: US 2015/0324825 A1
(43) Pub. Date: Nov. 12, 2015

(54) AUTOMATED IDENTIFICATION OF GEOGRAPHIC AUDIENCE BASED ON STORED MARKET DATA

(71) Applicant: Bookigee, Inc., Miami Shores, FL (US)

(72) Inventor: Kristen McLean, North Miami Beach, FL (US)

(21) Appl. No.: 14/711,450

(22) Filed: May 13, 2015

Related U.S. Application Data
(63) Continuation-in-part of application No. 14/214,589, filed on Mar. 14, 2014.
(60) Provisional application No. 61/782,258, filed on Mar. 14, 2013.

(51) Int. Cl. G06Q 30/02

(52) U.S. Cl. CPC G06Q 30/0205; G06Q 30/0202

(57) ABSTRACT

A server for identifying one or more audience opportunities for a target product, based on stored marketing data is provided that solves the above-described problem by using an automated process that aids publishers in identifying and, taking advantage of, audience opportunities for the target product. The server is configured for defining at least one existing comparable product that matches one or more characteristics of the target product, reading social media data and sales data for the target product, reading social media data and sales data for the comparable product, calculating one or more audience opportunities for the target product based on the data that was read, ranking the one or more audience opportunities for the target product based on the stored marketing data, which comprises consumer behavior data, and displaying the audience opportunities and the corresponding rankings in a geographic map.

### CROSS-REFERENCE TO RELATED APPLICATIONS

This patent application is a continuation in part of patent application Ser. No. 14/214,589 filed Mar. 14, 2014 and entitled “Automated Identification of Marketing Opportunities Based on Stored Marketing Data”, which claims priority to provisional patent application No. 61/782,258 filed Mar. 14, 2013 and entitled “Automated Identification of Marketing Opportunities Based on Stored Marketing Data”. The subject matter of application Ser. No. 14/214,589 and 61/782,258 are hereby incorporated by reference in their entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to automated processes for identifying target audiences for facilitating electronic commerce.

### BACKGROUND

Whereas in the past customer knowledge in the book publishing industry was largely based on a physical distribution model and available data was limited to the invoicing, sales, and returns data found in simple supply chain transactions, in recent years opportunities have arisen for the collection of a broad range of consumer data via electronic channels and processes. The types of raw data now being collected include but are not limited to: transactional sales data, real-time geographic and demographic data of the purchaser; electronic reviews; semantic data based on social media behavior such as likes, posts, hashtag keywords, and analysis of user-generated content; geographic distribution of all sales of a particular type of book or subject matter in a given time period; data on the other goods purchased at the time of a book purchased; and segmentation of a particular consumer into a demographic group based on the accumulation of all consumer purchases and behaviors in a given period, such that other metrics can be attached to that consumer relating to time-sensitive opportunities in the broader consumer market. The richness of this data offers publishers and other content creators the potential to composite these diverse forms of data and calculate the probable audiences for a particular property, brand, or consumer product with a high degree of precision. This would allow content vendors to determine the geographic distribution of a particular audience with specificity never before possible. Such specificity could lead to greater efficiencies in business decision-making, more effective targeting of both marketing messages and product distribution, and ultimately lead to cost reductions and large gains in growth.

However, the sheer volume of this data, coupled with the broad diffusion of this data across many types of servers and institutions, creates a barrier to entry for publishers and other content companies to reliably collect and integrate this information in order to create these actionable opportunities. The publishers and other content creators themselves hold only a small fraction of the necessary data. Other components of the data, such as third party sales data, may be inaccessible due to competitive factors. In addition, the large expenses and specialized knowledge required to build a dedicated data operation to undertake these types of complex and time-sensitive analyses require resources beyond of the reach of most publishers. Further, there exists no reliable third-party tool or service to cost-effectively access and aggregate the specialized data from multiple sources and deliver it in a format that allows multi-directional analysis. Finally, as the market for all content continues to expand, the volume of data being created and the difficulty of identifying and capturing new sources of insight becomes a barrier in and of itself. Therefore, the lack of integrated, affordable, reliable, and understandable intelligence becomes a significant barrier to growth and competitiveness, especially in the book publishing market.

Therefore, a need exists for improvements over the prior art, and more particularly for more effective methods and systems for collecting and integrating consumer data to create specific, geographically-based landscapes that identify audience opportunities for facilitating electronic commerce for a particular property, brand, or consumer product, especially in the book publishing industry.

### SUMMARY

A method, system, server and computer program product that collects data and predicts one or more target audience segments for a product, based on stored market data is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a server for identifying one or more audience segments for a target property, brand, or consumer product, hereafter called the “target product”, based on stored market data is provided that solves the above-described problem by using an automated process that aids a publisher in identifying and taking advantage of market opportunities for the target product. The server is configured for defining a series of characteristics of the target product, including but not limited to the genre category of the target product, the target demographic, similar comparable products to the target product, reading social media data and sales data related to both the target product, the comparable product and the overall genre, weighting and indexing all data according to various metrics, attaching geographic information to the data that was read, creating a series of geographically-based calculations for the various collections of defined data, which comprises consumer behavior data, and displaying the predicated audience opportunities and the corresponding rankings in a variety of forms that may include, but are not limited to, geographic maps, heat maps, bubble charts, cluster analyses, ranked text strings, and other analytic output.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports the automatic provision of audience opportunities for a target product, according to an example embodiment;

FIG. 2A is a diagram showing the data flow of the process for automatic provision of audience opportunities for a target product, according to an example embodiment;

FIG. 2B is a diagram showing the data flow of the algorithm used to determine audience opportunities for a target product, according to an example embodiment;

FIG. 3A is a flow chart of a method for the automatic provision of audience opportunities for a target product, according to an example embodiment;

FIG. 3B is an example embodiment of one data compositing process that might be used to build up the final predictive audience advice 206 to the inquiry agent

FIG. 3C is an illustration of a sample display of audience opportunities for a target product, according to an example embodiment;

FIG. 4 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Disclosed methods provide for automatic prediction of one or more audience opportunities for a target product, based on stored industry and consumer market data, thereby solving the above-described problem by using an automated process that aids publishers and others (such as agents, authors, or other inquiry agents) in identifying and taking advantage of, marketing and sales opportunities for the target product. The systems and methods of the present invention leverage the availability of book sales data, social network data and various consumer data to provide a quick and easy way for publishers to obtain automated market analysis. Further, the systems and methods of the present invention improve over the prior art by providing a publisher access to integrated, affordable, reliable, and understandable market-wide intelligence to guide business decision-making. Lastly, the systems and methods of the present invention provide analytics of audience and sales data to the publisher, which would otherwise not be available to them on an internal basis.

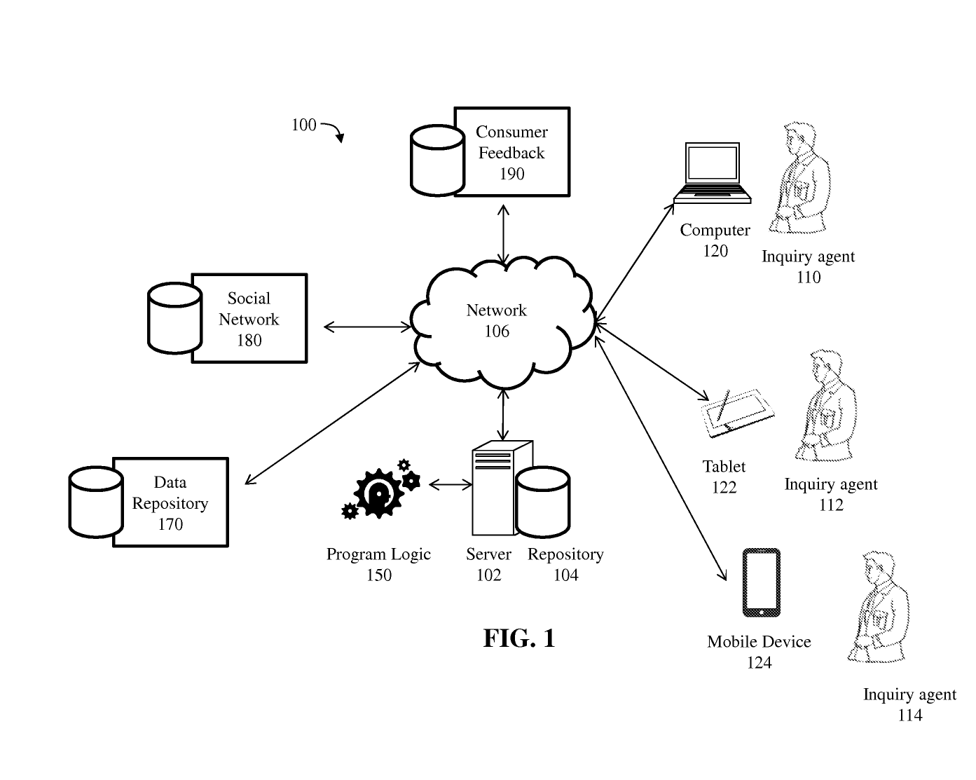

FIG. 1 is a block diagram of an operating environment 100 that supports the automatic provision of audience opportunities for a target product, such as a book, according to an example embodiment. In further embodiment, the operating environment 100 may support the automatic provision of audience opportunities for other products, including consumer packaged goods, as well as creative content such as music, movies, television shows, mobile apps, etc.

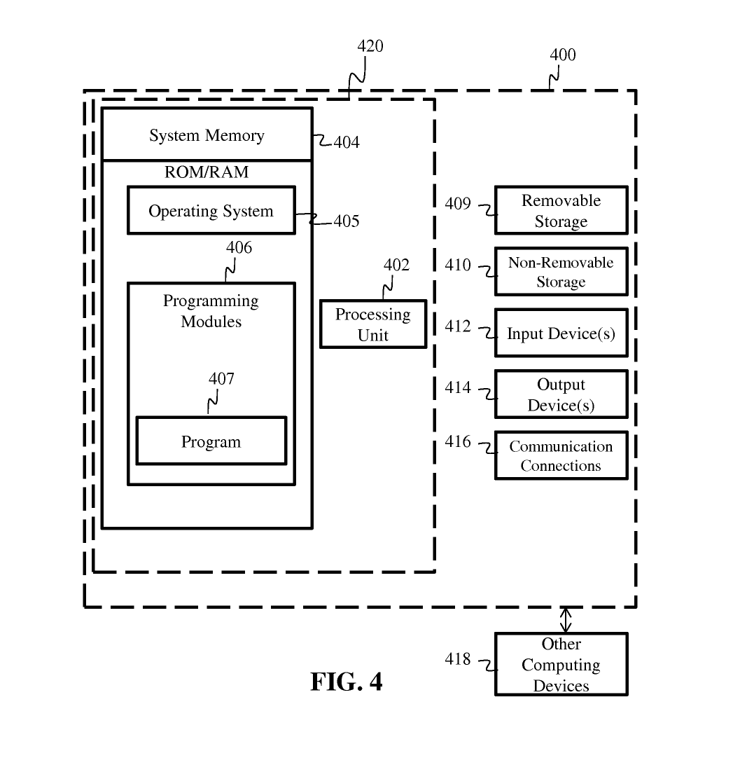

The environment 100 may comprise multiple client computers 120, 122, 124 and a server 102 communicating via a communications network 106. Each of the client computers 120, 122, 124 and server 102 may be connected either wirelessly or in a wired or fiber optic form to the communications network 106. Client computers 120, 122, 124 and server 102 may each comprise a computing device 400, described below in greater detail with respect to FIG. 4. FIG. 1 shows that client computers 120, 122, and 124 may comprise mobile computing devices such as cellular telephones, smart phones or tablet computers, or other computing devices such as a desktop computer, laptop, or game console, for example. Communications network 106 may be a packet switched network, such as the Internet, or any local area network, wide area network, enterprise private network, cellular network, phone network, mobile communications network, or any combination of the above.

Environment 100 may be used when multiple clients or, for example, publishers and their inquiry agents, 110, 112, 114 engage with server 102 to obtain market advice based on stored market data. Clients 110, 112, 114 may be self-published authors, agents, publishers, or other industry professionals, which are collectively referred to as inquiry agents. Data repository 170 refers to a third party entity that creates, stores or collects sales data and/or social networking data. Social network 180 refers to an online provider of conventional social network services to consumers such as Facebook, LinkedIn, Instagram, Pinterest, WhatsApp, SnapChat, and Twitter. Customer feedback 190 refers to a cache of consumer data which may be held by a third party entity that creates, stores or collects such data such as Goodreads or Amazon, or it may belong to the client themselves, for example direct-to-consumer data collected by publishers and their inquiry agents. Each client computer 120, 122, 124 may connect directly or indirectly to server 102, social network 180, data repository 170, and consumer feedback 190 as defined in method 300 below.

Data repository 170, social media network 180, consumer feedback 190, and server 102, are each associated with a database, such as database 104 for server 102. Each of the databases may hold social media data, which may include, for each user or social media account, but is not limited to, the total number of friends or followers of the user or account, the number of social media updates (such as posts, tweets, photos, interactions, etc.), the number of social media likes, or any of the data above divided or categorized by time, geographic region, density and virality (i.e., the state or condition of being viral or able to spread). Each of the databases may also hold sales data, which may include, for each product, total number of sales of each version of the product (such as printed books versus electronic books), library circulation data, or any of the data above divided or categorized by time, geographic region, density and virality, (i.e., the extent—by numbers—to which an item has become viral or able to spread via the Internet). Each of the databases may also hold customer feedback data such as frequency & recency of purchase, opinions, performance reviews, qualitative and quantitative research, stars and other aggregated ratings, product lists, and full text reviews which may or may not be parsed for semantic search. In addition, these databases may also include census data, product data, mobile usage data, and other types of specific market data pertaining to consumer behavior.

FIG. 1 shows an embodiment of the present invention wherein networked computing devices 120, 122, 124 interact with server 102, data repository 170, social network 180, customer feedback 190, and repository 104 over the network 106. Server 102 includes a software engine that delivers applications, data, program code and other information to networked computing devices 120, 122, 124. The software engine of server 102 may perform other processes such as transferring multimedia data in a stream of packets that are interpreted and rendered by a software application as the packets arrive. It should be noted that although FIG. 1 shows only three networked computing devices 120, 122, 124 the system of the present invention supports any number of networked computing devices connected via network 106.

Server 102 includes program logic 150 comprising computer source code, scripting language code or interpreted language code that is compiled to produce executable file or computer instructions that perform various functions of the present invention. In another embodiment, program logic 150 may be distributed among more than one of server 102, computers 120, 122, 124, or any combination of the above. In yet another embodiment, program logic 150 may comprise a programming module, as described in FIG. 4 below.

Note that although server 102 is shown as a single and independent entity, in one embodiment of the present invention, the functions of server 102 may be integrated with another entity, such as one of the client computers or one or more of 170, 180, 190. Further, server 102 and its functionality, according to a preferred embodiment of the present invention, can be realized in a centralized fashion in one computer system or in a distributed fashion wherein different elements are spread across several interconnected computer systems.

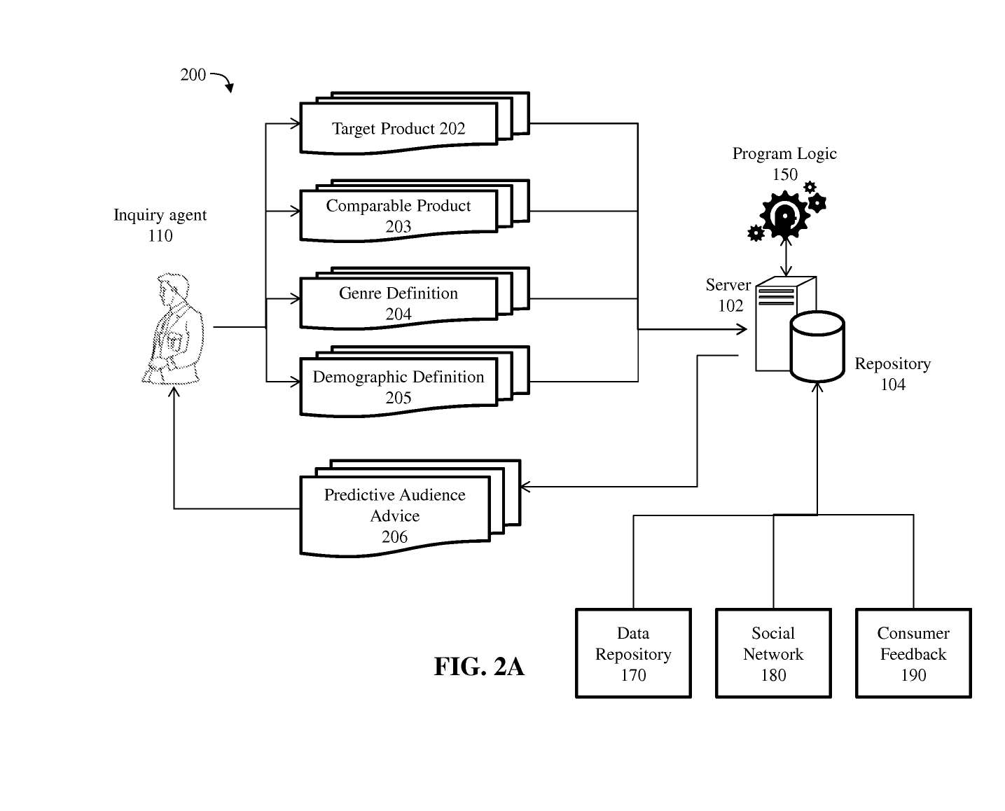

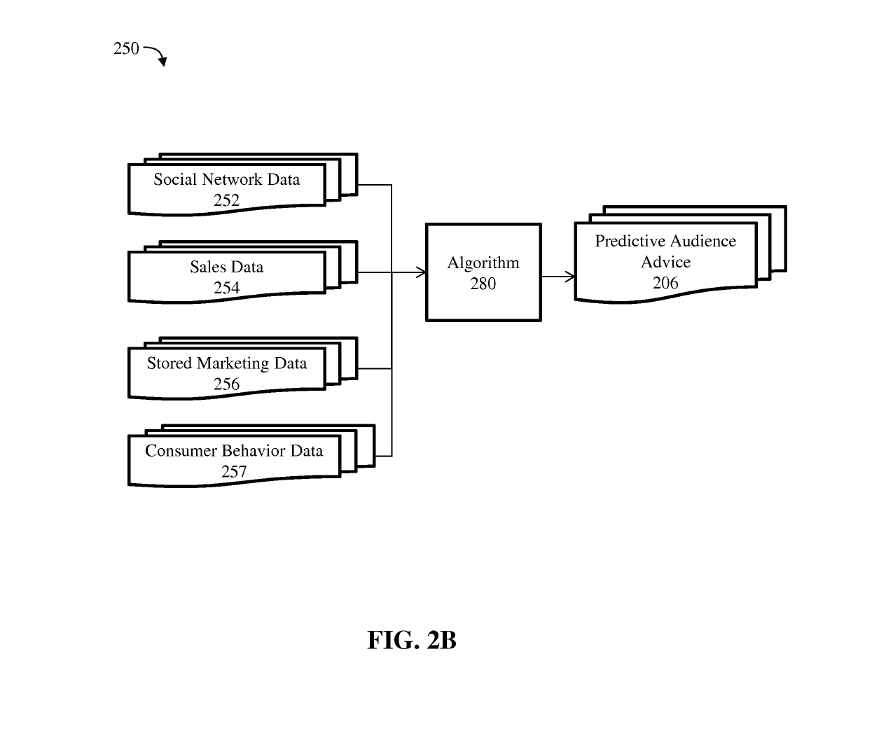

FIG. 2A is a diagram showing the data flow 200 of the process for automatic provision of audience opportunities for a target product, according to an example embodiment. FIG. 2A depicts the transfer of data from, for example, inquiry agent 110 to server 102, namely, the selection or identification of target product 202, a comparable product 203, a genre definition 204, and a demographic definition 205. The target product may comprise a printed book or an electronic book. Further, the comparable product may match one or more of the following characteristics of the target product: series, subject, category, author, region, related group, and any literary prizes bestowed upon the book. In one embodiment, the inquiry agent 110 selects or identifies a target product 202 to server 102 via an online graphical user interface (executing on the device 120 of agent 110) by clicking on a displayed selection or selecting a selection via a pull down menu. In another embodiment, the sever 102—in an automated fashion—finds a comparable product 203 (because it matches one or more of the following characteristics of the target product: genre, subject, category, author, region, related group, and any literary prizes bestowed upon the book). Thereafter, the server 102, via the network 106, displays one or more comparable products 203 for the inquiry agent 110 to select via the graphical user interface executing on the device 120 of agent 110.

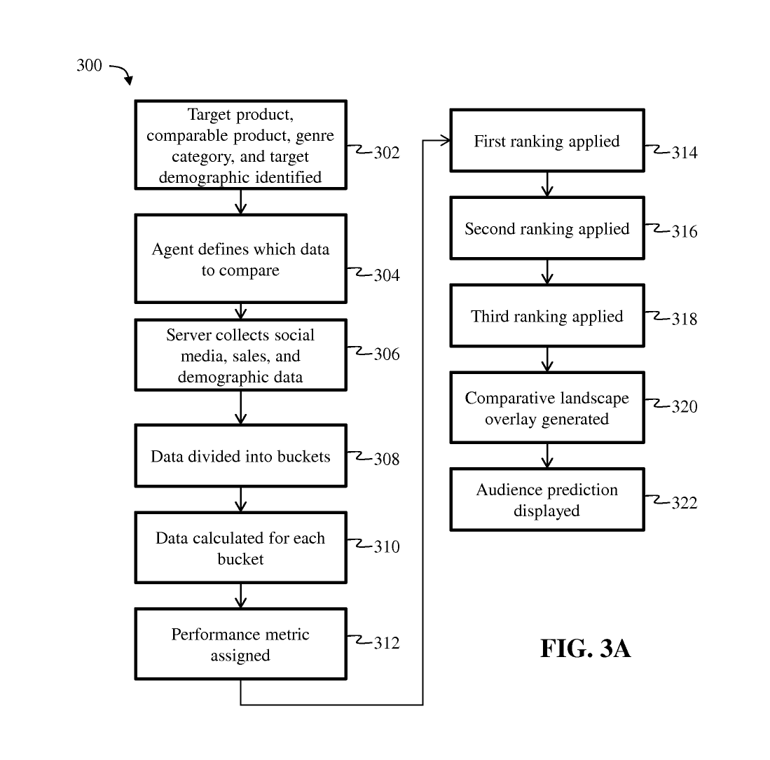

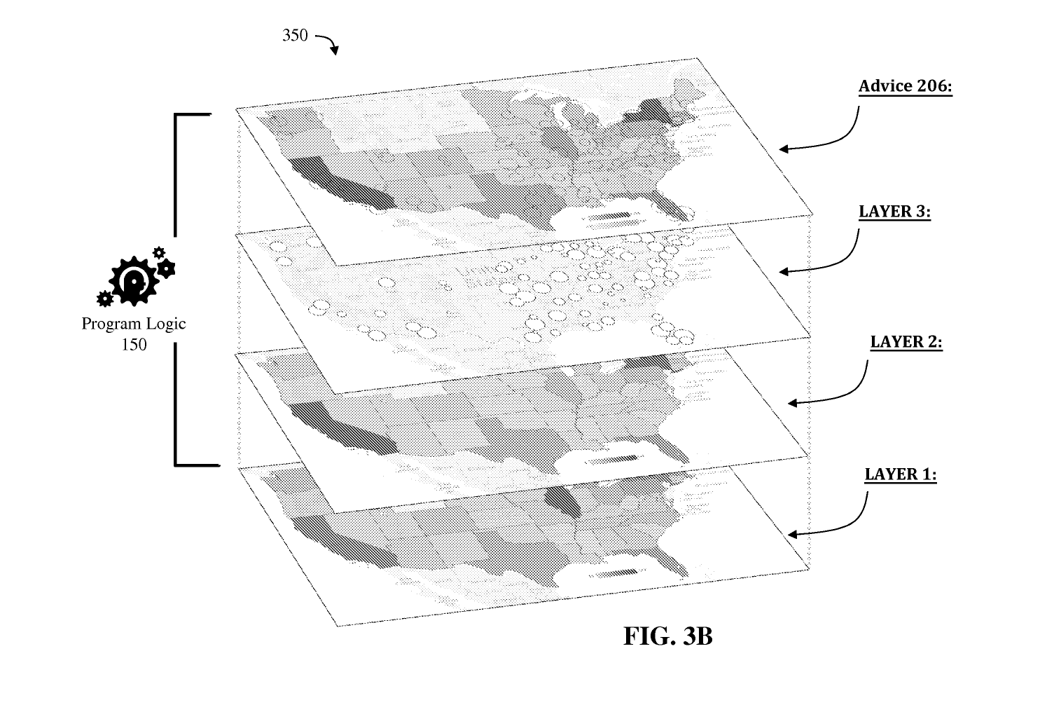

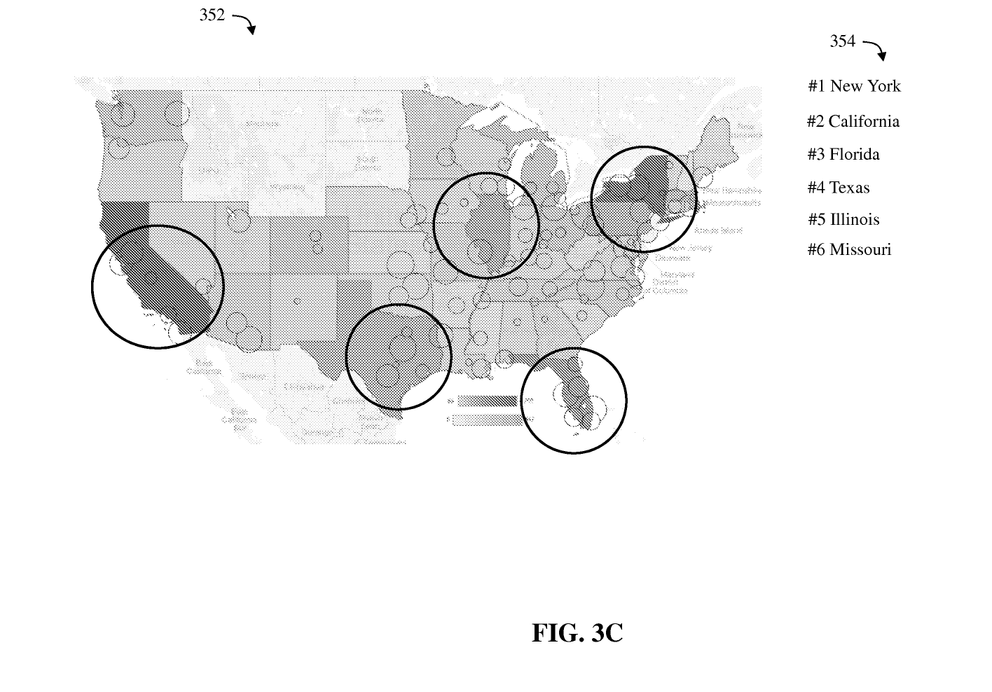

Consequently, the server 102 collects sales data and social network data (as defined above) from social network 180, and/or data repository 170, and/or customer feedback 190. Using the data it has collected, as well as other data that may be present in database 104, the server 102 then executes the calculations and algorithms for the method for automatic provision of audience opportunities for a target product, as defined in FIGS. 3A-3C below. As a result of the execution of the calculations and algorithms, the server 102 sends predictive audience advice 206 to the inquiry agent 110 for display on the device 120.

The predictive audience advice 206 may comprise new audience opportunities, sales opportunities, or existing customer development opportunities for the target product based on the data that was read by server 102. The predictive audience advice 206 may also comprise a ranking of the one or more audience opportunities for the target product based on stored market data, which comprises consumer behavior data. In one embodiment, the predictive audience advice may display the audience opportunities and the corresponding rankings in a geographic map, a map of weighted circles, a heat map, and/or a ranked list including text strings with an action, a social media indicator or a geographic indicia.

FIG. 2B is a diagram showing the data flow of the algorithm 280 used to determine audience opportunities for a target product 202, according to an example embodiment. FIG. 2B depicts the data inputs and outputs for the algorithm 280 used to determine audience opportunities for a target product 202. FIG. 2B shows that the algorithm 280 reads the social network data 252 (received from social network 180, for example) and sales data 254 (received from data repository 170, for example). FIG. 2B also shows that the algorithm 280 reads, or has already saved, stored marketing data 256, as well as consumer behavior data 257. In one embodiment, the stored marketing data 256 could include consumer behavior data. In an alternate embodiment consumer behavior data could reside in its own repository shows as consumer behavior data 257. FIG. 2B further shows that algorithm 280 outputs predictive audience advice 206, which may comprise new audience opportunities, sales opportunities, or existing customer development opportunities for the target product.

FIG. 3A is a flow chart of a method for the automatic provision of audience opportunities for a target product, according to an example embodiment. FIG. 3 depicts the actions of an example inquiry agent 110 attempting to obtain predictive audience advice and analytics on market and sales data for the purpose of increasing sales of his target product.

Method 300 may begin at stage 302 wherein the inquiry agent 110 provides a comparable product 203, as a proxy for his target product 202 to server 102 (as discussed above with reference to FIG. 2A). Next, in optional step 304, the inquiry agent 110 defines which of the aforementioned data from the comparable product 203 to compare to the target product 202. In certain cases, the comparable product 203 may only match the target product 202 in a limited way, such as by target age or thematic element (for example). In these cases, the inquiry agent 110 may specify, in this step, that the algorithm 280 should only compare certain specified characteristics (such as reader age or thematic element) of the comparable product 203 to the target product 202. This allows for a more precise comparison. In this step, the inquiry agent 110 may also specify genre definition 204 to benchmark opportunity against mean. One embodiment of this genre definition could be the use of a Book Industry Standards and Communications (BISAC) code, for example. In this step, the inquiry agent may also specify a demographic definition 205, which allows for filtering by one or more demographic factors, such as household income, ethnicity, familial composition, or religious affiliation, as examples.

In one embodiment of step 304, the inquiry agent 110 selects or identifies a certain specified characteristics to server 102 via an online graphical user interface (executing on the device 120 of agent 110) by clicking on a displayed selection or selecting a selection via a pull down menu. In another embodiment, the sever 102—in an automated fashion—determines the certain specified characteristics by doing a comparison of the target product 202 and comparable product 203.

Next, in step 306, the server 102 collects sales data 254 and social network data 252 (as defined above) from social network 180 and/or data repository 170, as well as consumer feedback 190. Using the data it has collected, as well as other data that may be present in database 104 (such as stored marketing data 256, and/or consumer behavior data 257), the server 102 then executes the calculations and algorithms of steps 308-318.

In step 308, sales data of comparable product 203, aggregated sales of books that fall within genre definition 204, and any additional data specified by inquiry agent in step 304 are divided into predetermined buckets. In one embodiment, each bucket might correspond to a geographic area, such as a zip code, area code, defined region, defined marketing area “DMA”, etc. Also in step 308, social media data, such as followers, friends, updates, etc., could be divided into the same predetermined buckets. In addition, one or more demographic dimensions as specified by demographic definition 205 would filter inbound data.

In step 310, various data in each bucket is calculated. In one embodiment, the following three pieces of data are calculated for each bucket on a geographic basis:

[% of sales of comparable product 203 in that bucket]

[% of sales of all books within genre definition 204 in that bucket]

[% of target product audience (as defined by stored demographic data or social media data) in that bucket]

wherein the comparable product audience corresponds to the audience for the author of target product 102, the product itself, a series of products of which the target product is a member, etc.

In step 312, using the data calculated in step 310, for each predefined bucket, such as such as a zip code, area code, defined region, defined marketing area “DMA”, a performance metric (i.e., a value, such as a percentage) is assigned to each item based on the frequency of sales versus a market average, mean, or index. In one embodiment, this market average, mean, or index could be constructed on a demographic dimension such as demographic definition 205 specified in step 304.

For example, in one embodiment, the following three pieces of data are calculated for each bucket on a geographic basis:

[% of sales of comparable product 203 in bucket] is <,>, or=[Mean Sales of comparable product within demographic definition 205]=% Performance metric (+/−100%).

[% of sales of all books in genre sales data grouping in bucket] is <,>, or=[Mean Sales of all genre sales data grouping]=performance metric (+/−100%).

[% of defined target product audience in bucket] is <,>, or=[Average frequency of defined target product audience across demographic definition 205]=performance metric (+/−100%).

These performance metrics are then averaged, to give each specified bucket—for example a geographic marker like a zip code, area code, defined region, defined marketing area “DMA—a master performance metric number that can be used to create an initial rank in subsequent steps.

In step 314, server 102 ranks the predetermined buckets via the master performance metrics assigned in step 312, from highest to lowest, creating an initial ranked opportunities list. In one embodiment, the multiple data points may also preserved individually to aid in various visualizations in the final output, predictive audience advice 206.

In step 316, server 102 executes a second ranking process by adding weights to the rankings of the market opportunities calculated in step 314. The weights may be based on a variety of stored marketing data, which comprises consumer behavior data, such as historic sales data, predictive sales data, social media data, demographic data, presence of high-frequency customers, retail presence, etc. In one example, the weights may be placed based on density, virality, and influence of the geographic bucket or consumer grouping relative to the genre of the target product. In another example, weights may be assigned on the basis of broader and more generalized demographic segmentation such as household income, the presence of institutions of higher learning, religious distribution, employment markets, housing markets, or other data. The data used to perform the ranking algorithm of step 316 may comprise a least a portion of the stored marketing data 256.

In step 318, server 102 executes a third ranking process by adding additional weights to the audience opportunities that were weighted in step 316. The weights may be based on a variety of data. In one example, the weights may be placed based on the relevance of the geographic bucket or consumer grouping to the inquiry agent's location and/or industry position relative to the original inquiry. In another embodiment this weighting could be placed on the author's relative distance to each geographic bucket, or whether the bucket contains a desirable market partner. The data used to perform the ranking algorithm of step 318 may comprise a least a portion of the stored marketing data 256.

As a result of the execution of the calculations and algorithms, in step 320, the server 102 creates a comparative landscape of the ranked data generated in steps 312-318. This landscape is created by compositing data into interactive layers which are then overlaid as shown in an example embodiment in FIG. 3B below. This data is then manipulated for optimal display to the inquiry agent 110. For example, the predictive audience advice could be displayed in a geographic map, a map of weighted circles, a heat map, and/or a ranked list including text strings with an action, a social media indicator or geographic indicia. In step 322, the predictive audience advice 206 is then sent to the inquiry agent 110 for display on his computer 120.

FIG. 3B is an example embodiment of one data compositing process that might be used to building up the final predictive audience advice 206 to the inquiry agent in step 320, described above. In this embodiment, each collection of weighted data is placed on a layer. In this example the data is placed into layered maps, where each map represents one collection of the specified data calculated in steps 308-318. Layer 1 is a calculated prediction of the total market audience for the genre definition 204, input in step 304, filtered and weighted by demographic definition 205. Layer 2 is a prediction of the likely audience for target product 202, based on the sales data of comparable product 203, consumer behavior data, and specific market weights as calculated in steps 308-318. Layer 3 is a calculation of a probable audience related to target product 202, based on social network data 252, stored marketing data 256, consumer behavior data 257, and consumer feedback 190. In this embodiment it is visualized as a bubble map. In this embodiment, these layers are composited together using the program logic 150 on server 102 to produce the predictive audience advice 206, which is then output to display on computer 120 of inquiry agent 110.

Server 102 includes program logic 150 comprising computer source code, scripting language code or interpreted language code that is compiled to produce executable file or computer instructions that perform various functions of the present invention. In another embodiment, program logic 150 may be distributed among more than one of server 102, computers 120, 122, 124, or any combination of the above. In yet another embodiment, program logic 150 may comprise a programming module, as described in FIG. 4 below.

FIG. 3C is an illustration of a sample display of likely audience distribution for a target product, according to an example embodiment. FIG. 3C shows example predictive audience advice 206 displayed on computer 120. The FIG. 352 depicts a blended visualization based the audience for the genre definition 204, audience analysis based on sales for the target product 202, and a social media landscape of active users related to these two landscapes, filtered by specific demographic variables, as calculated in steps 308-318, and output in an enhanced heat map. Circles indicate the five top market opportunities. The FIG. 354 shows analysis of the top audience opportunities and markets in a ranked text list, as calculated in 308-318.

FIG. 4 is a block diagram of a system including an example computing device 400 and other computing devices. Consistent with the embodiments described herein, the aforementioned actions performed by client computers 120, 122, 124, by server 102 and the entities 170, 180, 190 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for data flow 200 and method 300 as described above. Data flow 200 and method 300 may operate in other environments and are not limited to computing device 400.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module for executing the actions of program logic 150. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. a program module) may perform processes including, for example, one or more of data flow 200's and method 300's stages as described above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A server for identifying one or more audience opportunities for a target product, based on stored market data, wherein the server is configured for:
defining at least one existing comparable product that matches one or more characteristics of the target product;
defining at least one genre metric for creating a market average reading social media data and sales data for the comparable product;
filtering the data based on defined demographic dimensions;
calculating one or more audience opportunities for the target product based on the data that was read;
ranking the one or more audience opportunities for the target product based on the stored market data, which comprises consumer behavior data; and
displaying the audience opportunities and the corresponding rankings in a geographic map.

2. The server of claim 1, wherein the target product comprises a printed book or an electronic book.

3. The server of claim 2, wherein the comparable product matches one or more of the following characteristics of the target product: genre, subject, category, author, region, group, library circulation, and prize.

4. The server of claim 3, wherein social media data comprises one or more of total number of friends or followers, number of social media updates, number of social media likes, or any of the above with regard to time, geographic region, density and virality.

5. The server of claim 4, wherein sales data comprises one or more of total number of sales and number of sales with regard to outlet, time, and geographic region.

6. The server of claim 5, wherein the step of calculating one or more audience opportunities for the target product based on the data that was read further comprises calculating one or more audience opportunities for the target product by identifying those market aspects of the comparable product which resulted in sales of the comparable product, but which market aspects are not being implemented by the target product.

7. The server of claim 6, wherein the step of ranking the one or more audience opportunities for the target product further comprises ranking the one or more audience opportunities based on one or more the following aspects: the percentage sales of a comparable product versus a overall market average, index, or mean of books like the target product based on genre, a geographic distance of a predicted audience opportunity from a hometown of an author of the target product, and density, virality, and influence of each geographic location relative to a genre of the target product.

8. The server of claim 7, wherein the step of displaying the audience opportunities and the corresponding rankings in a geographic map further comprises displaying one or more of a map of weighted circles, and/or a heat map, and/or a ranked list.

9. A server for collecting data for facilitating and identifying one or more audience opportunities for a target product, based on stored marketing data, wherein the server is configured for:
collecting social media data and sales data for the target product and at least one existing comparable product that matches one or more characteristics of the target product;
receiving a request for social media data and sales data for the target product and the at least one existing comparable product; and
transmitting the social media data and the sales data that was requested for the target product and the at least one existing comparable product, wherein the social media data and the sales data are used for:
filtering the requested data by specified demographic dimensions;
calculating one or more audience opportunities for the target product based on the data that was read;
ranking the one or more audience opportunities for the target product based on the stored marketing data, which comprises consumer behavior data; and
displaying the audience opportunities and the corresponding rankings in a geographic map and/or heat map, and/or ranked list.

10. The server of claim 9, wherein the target product comprises a printed book or an electronic book.

11. The server of claim 10, wherein the comparable product matches one or more of the following characteristics of the target product: genre, subject, category, author, region, group, library circulation, and prize.

12. The server of claim 1, wherein social media data comprises one or more of total number of friends or followers, number of social media updates, number of social media likes, or any of the above with regard to time, geographic region, density and virality.

13. The server of claim 12, wherein sales data comprises one or more of total number of sales and number of sales with regard to outlet, time, and geographic region.

14. One or more servers for collecting data and identifying one or more audience opportunities for a target product, based on stored marketing data, wherein the one or more servers are configured for:
defining at least one existing comparable product that matches one or more characteristics of the target product;
collecting social media data and sales data for the target product;
collecting social media data and sales data for the at least one existing comparable product;
filtering the data based on defined demographic dimensions;
calculating one or more audience opportunities for the target product based on the data that was read;
ranking the one or more audience opportunities for the target product based on the stored marketing data, which comprises consumer behavior data; and
displaying the audience opportunities and the corresponding rankings in a geographic map, and/or a heat map, and/or a ranked list.

15. The one or more servers of claim 14, wherein the target product comprises a printed book or an electronic book.

16. The one or more servers of claim 15, wherein the comparable product matches one or more of the following characteristics of the target product: genre, subject, category, author, region, group, and prize.

17. The one or more servers of claim 16, wherein social media data comprises one or more of total number of friends or followers, number of social media updates, number of social media likes, or any of the above with regard to time, geographic region, density and virality.

18. The one or more servers of claim 17, wherein sales data comprises one or more of total number of sales and number of sales with regard to outlet, time, and geographic region.

19. The one or more servers of claim 18, wherein the step of calculating one or more audience opportunities for the target product based on the data that was read further comprises calculating one or more audience opportunities for the target product by identifying those market aspects of the comparable product which resulted in sales of the comparable product, but which market aspects are not being implemented by the target product.

20. The one or more servers of claim 19, wherein the step of ranking the one or more audience opportunities for the target product further comprises ranking the one or more audience opportunities based on one or more the following aspects: a percent of the target product's existing audience in each audience opportunity, a geographic distance of each audience opportunity from a hometown of an author of the target product, and density, virality, and influence of each geographic location relative to a genre of the target product.
